(19) United States
(12) Patent Application Publication
(10) Pub. No.: US 2018/0004199 A1
(43) Pub. Date: Jan. 4, 2018

(54) CONTROL SYSTEM FOR A TRANSIT MIXER VEHICLE

(71) Applicant: Kimble Mixer Company, New Philadelphia, OH (US)

(72) Inventors: Leopha Chester Randolph, III, New Philadelphia, OH (US); Adam Herbert Wade, Canton, OH (US)

(21) Appl. No.: 15/640,411

(22) Filed: Jun. 30, 2017

Related U.S. Application Data
(60) Provisional application No. 62/357,001, filed on Jun. 30, 2016.

(51) Int. Cl. G05D 1/00; B60W 10/06; B28C 5/42; B60P 3/16; B60W 10/20; B60W 10/10

(52) U.S. Cl. CPC G05D 1/0011; B60W 10/20; B60W 10/10; B28C 5/422; B60P 3/16; B60W 10/06

(57) ABSTRACT

A transit mixer vehicle includes a chassis. Various vehicle components are mounted to the chassis. A mixer system for construction material is supported by the chassis. The mixer system includes a container and an agitator capable of stirring construction material disposed within the container. The transit mixer vehicle also includes a component communications system including a Controller Area Network (CAN) bus in communication with the plurality of vehicle components. A receiver is coupled with CAN bus. The receiver is operative to wirelessly receive instructions from a remote-control unit and direct at least one of the vehicle components based upon the instructions received from the remote-control unit.

### CROSS-REFERENCE TO RELATED APPLICATIONS

This application claims the benefit of and priority to U.S. Provisional Application No. 62/357,001, filed 30 Jun. 2016, the contents of which is hereby incorporated by reference in its entirety.

### BACKGROUND

Construction vehicles for the transport of construction materials are generally known. One type of construction vehicle is the transit mixer. Transit mixer vehicles are used to transport certain construction materials to worksites and/or mix these materials on site. These transit mixer vehicles may be used to offload or unload particular material(s) in amounts and at locations as desired. Transit mixer vehicles are generally able to be maneuvered to desired location at a worksite, where the material may be offloaded, for example. In one operation, a load is discharged out of an opening in a container of the transit mixer vehicle and travels down a chute to the desired location.

### SUMMARY

A transit mixer vehicle includes a chassis. A plurality of vehicle components are mounted to the chassis. A mixer system for construction material is supported by the chassis. The mixer system may include a container and an agitator capable of stirring construction material is disposed within the container. The container may be a drum and the construction material may be, for example, concrete. The mixer system may also include a hopper and/or a chute.

The transit mixer vehicle also includes a component communication system. The component communications system preferably includes a Controller Area Network (CAN) bus in communication with the various components of the vehicle.

A receiver is coupled with the CAN bus to wirelessly receive instructions from a remote-control unit and direct vehicle components based upon the instructions received from the remote-control unit.

In at least one embodiment, components and systems of a transit mixer vehicle can be controlled through operation of a remote control unit in wireless communication with a receiver coupled to a CAN bus to which the components or systems are also coupled. This may include certain operations, including, but not limited to, steering of the vehicle and unloading of construction materials. The transit mixer vehicle may be used to transport certain materials, for example, concrete, to a worksite. Upon arrival at the worksite, the transit mixer vehicle may be remotely maneuvered to offload the material.

### BRIEF DESCRIPTION OF THE DRAWINGS

FIG. 1 is a side view of a transit mixer according to an embodiment.

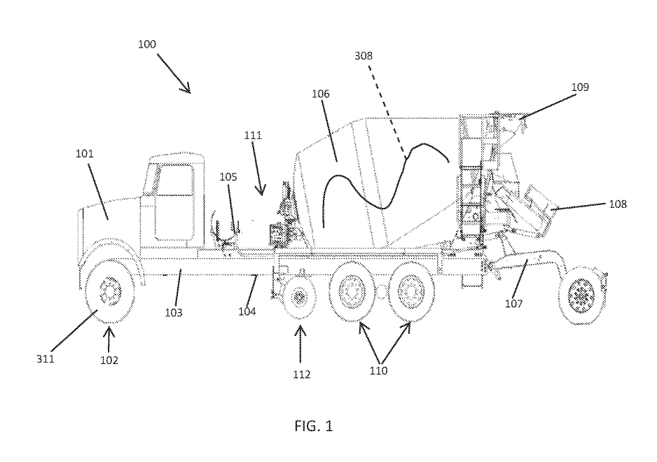

FIG. 2 is a schematic diagram of the component communication system of the transit mixer vehicle of FIG. 1.

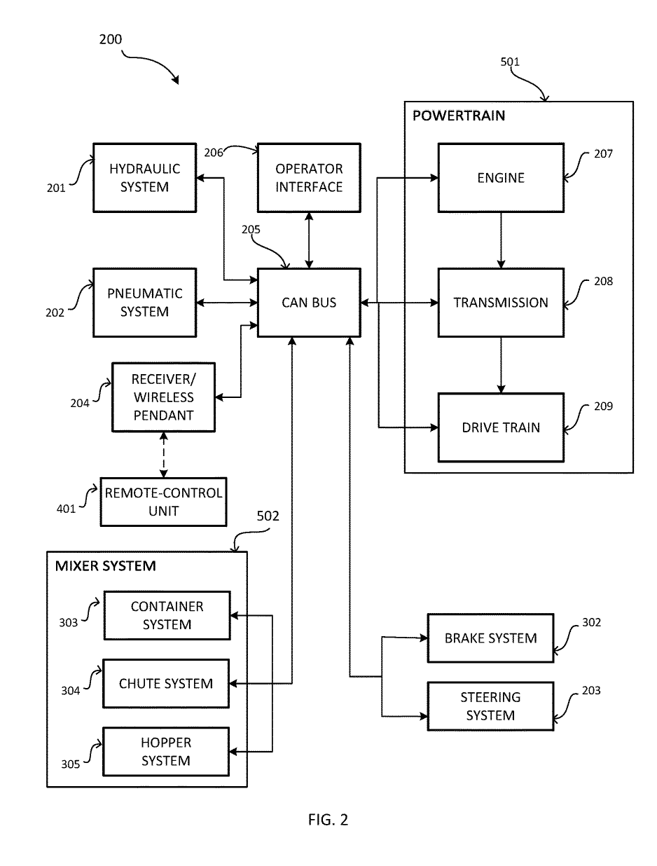

### DETAILED DESCRIPTION

Referring now to the drawings, a transit mixer 100 includes a chassis 103. A variety of components are generally mounted on or supported by the chassis 103. These components may include but are not limited to the parts of a powertrain 501, including an engine 101, which is coupled to a transmission 208, which is coupled to a drivetrain 209 including a transfer case 104 and drive axles 110. These components may also include a steering system 203 which includes a steer axle 102, and a brake system 302, and may also include a hydraulic system 201 including a hydraulic pump 105 for powering hydraulic devices. There may also be a pneumatic system 202 for powering pneumatic devices. These components may also include a plurality of wheels 311, a bridge axle 107 and an auxiliary axle 112. Further, these components may include the parts of a mixer system 502 including container system 303 having a container 106, an agitator 308, and a container drive 111, a chute system 304 including a chute 108, and a hopper system 305 including a hopper 109. These components collectively or individually may, in whole or in part, make up certain systems or sub-systems of the transit mixer 100.

The transit mixer 100 includes a component communication system 200. The system 200 includes a Controller Area Network (CAN) bus 205 for communication with or between components, systems or subsystems of the transit mixer vehicle 100. An operator interface 206, such as in-cab-controls is coupled to the CAN bus 205 for communication with the components, systems or subsystems. Further, a receiver 204, which is depicted as a wireless pendant, although such is not required, is also coupled to the CAN bus 205 for communication with the components, systems or subsystems. The receiver 204 is operative to receive signals or instructions from a remote control unit 401 to then via the CAN bus 205 direct the components, systems or subsystems, such as the hydraulic system 201, the pneumatic system 202, the steering system 203, the powertrain 501 or the components there of, or any other component, system or subsystem as desired. It must be understood that the receiver 204 may include, be couple with or otherwise cooperate with a transmitter, relay or other device to enable the transmission or relay of signal, instructions or data to components via the CAN bus 205.

It must be understood that these systems, including but not limited to the hydraulic and pneumatic systems 201 and 202 may be powered by the separate engines (not shown) or by the engine 101 of the transit mixer vehicle 100. The hydraulic system 101 or the pneumatic system 202 may provide hydraulic fluid power or air power for the operation of parts of all of the powertrain 501, the mixer system 502 the steering system 203, the bridge axle 107, and/or the brake system 302, as desired. The brake system 302 may include a main brake, a service brake, a parking brake, and/or a chassis brake.

In at least one embodiment, the hydraulic pump 105 provides the fluid power required for the operation of the mixer system 502. The mixer system 502 is operable remotely with the remote-control unit 401 via the receiver 204 and the CAN bus 205.

In at least one embodiment, the plurality of vehicle components are mounted to the chassis 103. The container 106 for construction material is supported by the chassis 103, and the agitator 309 for stirring construction material disposed within the container 106 and is associated with the container 106. The plurality of vehicle components and the receiver 204 are coupled to the CAN bus 205 for communication. The receiver 204 is operative to wirelessly receive instructions from the remote-control unit 401 and direct at least one of the plurality of vehicle components based upon the instructions received.

In at least one embodiment, the CAN bus 205 is operable in multiplexing mode.

In at least one embodiment, the pneumatic system 202 includes a pump, a tank, and a valve.

In at least one embodiment, the container 106 is a rotatable drum.

In at least one embodiment, the transit mixer vehicle 100 includes the container control system 303 which can be instructed by the receiver 204 based upon instructions received wirelessly from the remote-control unit 401 to load or offload construction material from the container 106. In at least one other embodiment, instructions may be received to change the rotational speed and/or rotational direction of the container 106.

In at least one embodiment, the remote-control unit 401 operates via wireless line of sight transmission with the receiver 204 being responsive to wireless line of sight transmission from the unit 401.

In at least one embodiment with the transit mixer vehicle 100 including the chute system 304 having the mixer chute 108, a controller of the chute system 304 may be instructed by the receiver 204 via the CAN bus 205 based upon instructions received wirelessly from the remote-control unit 401 to move the mixer chute in relation to the container 106. The instructions may include a direction for movement of the mixer chute 108 in one of a left, a right, an up, or a down direction in relation to the container 106. The instructions also can include a direction for opening and/or closing mixer chute 108 cylinder.

In at least one embodiment with transit mixer vehicle 100 having the hopper system 305 having the hopper 109, a controller of the hopper system 305 may be instructed by the receiver 204 via the CAN bus 205 based upon instructions received wirelessly from a remote-control unit 401 to turn on and/or off the hopper 109.

In at least one embodiment with the transit mixer vehicle 100 having the hydraulic system 201, a controller of the hydraulic system 201 may be instructed by the receiver 204 via the CAN bus 205 based upon instructions received wirelessly from the remote-control unit 401.

In at least one embodiment with the transit mixer vehicle 100 having the steering system 203, a controller of the steering system 203 may be instructed by the receiver 204 via the CAN bus 205 based upon instructions received wirelessly from the remote-control unit 401 to adjust steering of the transit mixer vehicle 100. The instructions can relate to turning at least one of the plurality of wheels 311 of the transit mixer vehicle 100 left or right, for example.

In at least one embodiment with the transit mixer vehicle 100 having the powertrain 501, a controller of a component of the powertrain 501, such as the engine 207, transmission 208, or the drivetrain 209, may be instructed by the receiver 204 via the CAN bus 205 based upon instructions received wirelessly from the remote-control unit 401. For example this instruction may include, but not be limited to, to shift the transmission 208 or change the state of the transfer case 104, or to govern or regulate the engine 207, for example by increasing or decreasing the engine RPMs.

In at least one embodiment with the transit mixer vehicle 100 having the brake system 302, a controller of a component of the brake system 302 may be instructed by the receiver 204 via the CAN bus 205 based upon instructions received wirelessly from the remote-control unit 401. For example this instruction may include, but not be limited to activation of an emergency stop system where the emergency stop system may also result in the cease of operations of a plurality of vehicle components.

In at least one embodiment the remote-control unit 401 includes at least one joystick and/or at least one display screen.

In at least one embodiment where there is a combination of the receiver 204 and the remote-control unit 401, the receiver 204 is coupled with the CAN bus 205 and the receiver 204 is operative to wirelessly receive instructions from the remote-control unit 401 and direct at least one of the plurality of vehicle components of a transit mixer vehicle 100 based upon the instructions received via the CAN bus 205.

In at least one embodiment where there is a combination of the transit mixer vehicle 100 and a remote-control unit 401, and the transit mixer vehicle 100 has the chassis 103 with the plurality of vehicle components mounted to the chassis 103; such as the container 106 for construction material supported by the chassis 103; the agitator 309 associated with the container 106 for stirring construction material disposed within the container 106; and the plurality of vehicle components and the receiver 204 are coupled with the CAN bus 205; the remote-control unit 401 is operable to communicate with the receiver 204. For example the remote-control unit 401 may be operative to wirelessly transmit instructions to the receiver 204, and the receiver 204 may be operative to wirelessly receive instructions from the remote-control unit 401 and direct at least one of the plurality of vehicle components via the CAN bus based upon the instructions received.

In at least one embodiment, the transit mixer vehicle 100 may be controlled by the remote-control unit 401 by sending instructions to the receiver 204 associated with the transit mixer vehicle 100, the receiver 204 receiving the instructions and, in response to receiving the instructions, subsequently directing at least one of a plurality of vehicle components through a component communication system 200 of the transit mixer vehicle 100.

While principles and modes of operation have been explained and illustrated with regard to particular embodiments, it must be understood, however, that this may be practiced otherwise than as specifically explained and illustrated without departing from its spirit or scope

What is claimed is:

1. A transit mixer vehicle comprising:
a chassis;
a container for construction material supported by said chassis;
an agitator associated with said container for stirring construction material disposed within said container;
a plurality of vehicle components mounted to said chassis;
a component communication system including a Controller Area Network (CAN) bus coupled with the plurality of vehicle components; and
a receiver coupled with said CAN bus, said receiver operative to wirelessly receive instructions from a remote-control unit and direct at least one of the plurality of vehicle components based upon the instructions received.

2. The transit mixer vehicle of claim 1 where said CAN bus is operable in a multiplexing mode.

3. The transit mixer vehicle of claim 1 where said plurality of vehicle components includes at least one component of controller for a component of a powertrain system, a brake system controller, a steering system controller, a controller for a component of a mixer system, a hydraulic system controller, and a pneumatic system controller.

4. The transit mixer vehicle of claim 1 further comprising a container control system including a container control system controller, where said container control system controller is operable to receive instructions from said receiver via the CAN bus based upon instructions received wirelessly from the remote-control unit.

5. The transit mixer vehicle of claim 1 where said receiver is operable to receive wireless line of sight communication from the remote-control unit.

6. The transit mixer vehicle of claim 1 further comprising a chute system controller for controlling a mixer chute of the transit mixer vehicle, where said chute system controller is responsive to said receiver based upon instructions received wirelessly from the remote-control unit to move the mixer chute in relation to the container.

7. The transit mixer vehicle of claim 1 further comprising a hopper system controller for controlling a hopper of the transit mixer vehicle, where said hopper system controller is responsive to the receiver based upon instructions received wirelessly from the remote-control unit to one of turn on and off the hopper.

8. The transit mixer vehicle of claim 1 further comprising a steering system controller where said steering system controller is responsive to said receiver based upon instructions received wirelessly from the remote-control unit to adjust steering of the transit mixer vehicle.

9. The transit mixer vehicle of claim 1 further comprising a transmission controller where said transmission controller is responsive to said receiver based upon instructions received wirelessly from the remote-control unit to shift a transmission of the transit mixer vehicle.

10. The transit mixer vehicle of claim 1 further comprising a hydraulic system including a hydraulic system controller where said hydraulic system controller is responsive to the receiver based upon instructions received wirelessly from the remote-control unit.

11. The transit mixer vehicle of claim 1 further comprising an engine controller where said engine controller is responsive to said receiver based upon instructions received wirelessly from the remote-control unit.

12. A combination of a transit mixer vehicle and a remote-control unit comprising:
a transit mixer vehicle including:
a chassis;
a container for construction material supported by said chassis;
an agitator associated with said container for stirring construction material disposed within said container;
a plurality of vehicle components mounted to said chassis;
a component communication system including a Controller Area Network (CAN) bus coupled with the plurality of vehicle components; and
a receiver coupled with said controller area network; and
a remote-control unit for communication with said receiver, said remote-control unit operative to wirelessly transmit instructions to the receiver,
where said receiver is operative to wirelessly receive said instructions from said remote-control unit and direct via the CAN bus at least one of the plurality of vehicle components based upon the instructions received.

13. The combination of claim 12 where said CAN bus is operable in a multiplexing mode.

14. The combination of claim 12 where said plurality of vehicle components includes at least one component of a controller for a component of a powertrain system, a brake system controller, a steering system controller, a controller for a component of a mixer system, a hydraulic system controller, and a pneumatic system controller.

15. The combination of claim 12 where the transit mixer vehicle further includes a container control system including a container control system controller, where said container control system controller is operable to receive instructions from said receiver via the CAN bus based upon instructions received wirelessly from the remote-control unit.

16. The combination of claim 12 where said receiver is operable to receive wireless line of sight communication from the remote-control unit.

17. The combination of claim 12 further comprising a chute system controller for controlling a mixer chute of the transit mixer vehicle, where said chute system controller is responsive to said receiver based upon instructions received wirelessly from the remote-control unit to move the mixer chute in relation to the container.

18. The combination of claim 12 where the transit mixer vehicle further includes a hopper system controller for controlling a hopper of the transit mixer vehicle, where said hopper system controller is responsive to receiver based upon instructions received wirelessly from the remote-control unit to one of turn on and off the hopper.

19. The combination of claim 12 where the transit mixer vehicle further includes a steering system controller where said steering system controller is responsive to said receiver based upon instructions received wirelessly from the remote-control unit to adjust steering of the transit mixer vehicle.

20. The combination of claim 12 where the transit mixer vehicle further includes a transmission controller where said transmission controller is responsive to said receiver based upon instructions received wirelessly from the remote-control unit to shift a transmission of the transit mixer vehicle.

21. The combination of claim 12 where the transit mixer vehicle further includes a hydraulic system including a hydraulic system controller where said hydraulic system controller is responsive to receiver based upon instructions received wirelessly from the remote-control unit.

22. The combination of claim 12 where the transit mixer vehicle further includes an engine controller where said engine controller is responsive to said receiver based upon instructions received wirelessly from the remote-control unit.

23. A combination of a receiver and a remote-control unit comprising:
a remote-control unit operative to wirelessly issue instructions; and
a receiver coupled with a component communication system, said receiver operative to wirelessly receive instructions from the remote-control unit and relay the instructions to at least one of a plurality of vehicle components of a transit mixer vehicle based upon the instructions received.

24. The combination of claim 23 where said component communication system is a Controller Area Network (CAN) bus operable in a multiplexing mode.

25. The combination of claim 23 where said plurality of vehicle components includes at least one component of controller for a component of a powertrain system, a brake system controller, a steering system controller, a controller for a component of a mixer system, a hydraulic system controller, and a pneumatic system controller.

26. The combination of claim 24 where the plurality of transit mixer vehicle components includes a container control system including a container control system controller, where said container control system controller is operable to receive instructions from said receiver via the CAN bus based upon instructions received wirelessly from the remote-control unit.

27. The combination of claim 23 where said receiver is operable to receive wireless line of sight communication from the remote-control unit.

28. The combination of claim 23 where the transit mixer vehicle further includes a chute system controller for controlling a mixer chute of the transit mixer vehicle, where said chute system controller is responsive to said receiver based upon instructions received wirelessly from the remote-control unit to move the mixer chute in relation to a container.

29. The combination of claim 23 where the transit mixer vehicle further includes a hopper system controller for controlling a hopper of the transit mixer vehicle, where said hopper system controller is responsive to receiver based upon instructions received wirelessly from the remote-control unit to one of turn on and off the hopper.

30. The combination of claim 23 where the transit mixer vehicle further includes a steering system controller where said steering system controller is responsive to said receiver based upon instructions received wirelessly from the remote-control unit to adjust steering of the transit mixer vehicle.

31. The combination of claim 23 where the transit mixer vehicle further includes a transmission controller where said transmission controller is responsive to said receiver based upon instructions received wirelessly from the remote-control unit to shift a transmission of the transit mixer vehicle.

32. The combination of claim 23 where the transit mixer vehicle further includes a hydraulic system including a hydraulic system controller where said hydraulic system controller is responsive to receiver based upon instructions received wirelessly from the remote-control unit.

33. A method for controlling a transit mixer vehicle comprising:
sending a signal from a remote-control unit
receiving, with a receiver associated with a transit mixer vehicle, the signal;
in response to receiving the signal, subsequently directing a component of the transit mixer vehicle via a component communication system.
